(19) United States
(12) Patent Application Publication
(10) Pub. No.: US 2026/0364659 A1
(43) Pub. Date: Nov. 19, 2026

(54) DRIVE DEVICE FOR OUTPUT MOVEMENT OF A DISPLACEMENT ELEMENT AND A DEVICE FOR PRODUCING THREAD AND PROFILES ON BLANKS WITH SAID DRIVE DEVICE

(71) Applicants: EJOT SE & Co. KG, Bad Berleburg (DE); REDIMO Gesellschaft für Handel mit Maschinen für die Umformtechnik mbH, Willich (DE)

(72) Inventor: Volker WENGENROTH, Hilden (DE)

(21) Appl. No.: 19/480,359

(22) PCT Filed: May 3, 2024
(86) PCT No.: PCT/EP2024/062324

§ 371 Date: Oct. 30, 2025

(30) Foreign Application Priority Data
May 3, 2023 (DE) 10 2023 111 500.6

(51) Int. Cl. B21C 3/08; F16C 32/00

(52) U.S. Cl. CPC B21C 3/08; F16C 32/00

(57) ABSTRACT

A drive device (10) for an output movement of a displacement element comprises a connecting rod (12) which is connected to the displacement element. The drive device (10) comprises a crank (22) and an eccentric unit (26). The eccentric unit (26) has a mechanical setting device (36), comprising a setting element (38) which acts on an eccentric element (40), wherein the setting device (36) is designed such that the setting element (38) can adopt different setting positions relative to the crank rotational axis, specifically position and/or orientation, wherein the setting element (38) can be locked in said setting position, and wherein an orbit of the eye-type bearing axis (ALA) about the crank rotational axis (KDA) is allocated to a setting position.

The invention relates to a drive device for the output movement of a displacement element, of the type specified in the preamble of claim 1.

Drive devices for the output movement of a displacement element are sufficiently well known in the prior art. They are integrated into thread rolling machines, for example, for the purpose of generating a linear back and forth movement of a movable rolling die relative to a stationary rolling die arranged in parallel thereto, as a thread and/or a profile is being made on a blank located between the two rolling dies. After half a turn, the profile rolled onto a blank must run exactly into the profile of the other rolling die. This makes it necessary to coordinate the respective longitudinal movement of the rolling dies. To ensure reproducible production of high-quality threads, the rolling dies need to operate with high accuracy whilst being precisely aligned with one another.

For example, DE 2 413 035 A, U.S. Pat. Nos. 3,308,642 A and 3,117,473 A each disclose a drive device for a thread rolling machine that can move a displacement element, for example a rolling die, back and forth. The drive device comprises a connecting rod which has its one end connected to the displacement element and has a connecting rod eye at the other end, in which an eye-type bearing is arranged, which is connected to an eccentric unit via an eye-type bearing axis. Via a bearing of the eccentric unit, the latter is connected to a rotatable crank of the drive device. The eccentricity of the eye-type bearing axis can be adjusted relative to the crank rotational axis.

The adjustment of the displacement element in the longitudinal direction, in particular the stroke position of a movable rolling die, which is determined by the starting position and the maximum stroke position, depends on the product parameters of the screw to be manufactured or on the manufacturing tolerance of a pair of rolling dies. With the known prior art, making such an adaptation would be very costly and time-consuming.

It is the object of the invention to propose a drive device for the output movement of a displacement element, which allows a stroke position of the displacement element to be adjusted continuously and precisely with high reproducibility and in a simple manner. In particular, it should allow for automated setting.

This object is accomplished by the characterizing features of claim 1 in conjunction with the features of its preamble.

The subclaims relates to advantageous further embodiments.

In a known manner, a drive device which performs an output movement of a displacement element comprises a connecting rod which has a connecting rod eye at a first end thereof and a guide element at a second end thereof, which guide element is connected to the movable displacement element. The displacement element can, for example, be a tool, the linkage of the tool or the like.

The guide element is mounted in such a way that it essentially performs a translatory movement in a guide direction. The guide element is preferably mounted so that it can rotate and/or pivot about a guide element axis.

The drive device comprises a crank, which is designed for example as a crank arm or a crank wheel and which is mounted for rotation about a crank rotational axis. In particular, the crank can be mounted on a housing. The crank is a driven element of the drive device and can have drive structures, e.g. external teeth, via which it is driven. This allows the crank to sweep through a crank angle.

The drive device furthermore has an eccentric unit which has an eye-type bearing and an eccentric unit bearing. The eye-type bearing, which has an eye-type bearing axis, connects the eccentric unit to the connecting rod eye in such a way that the connecting rod eye can be rotated about the eye-type bearing axis.

The eccentric unit is connected to the crank via the eccentric unit bearing. The eccentric unit bearing defines an eccentric unit bearing rotational axis, which is arranged at a fixed distance from the crank rotational axis. With one revolution of the crank, a connecting line between the crank rotational axis and the eccentric bearing rotational axis rotates around the crank rotational axis. The distance between the eccentric unit bearing rotational axis and the crank rotational axis is greater than the distance between the eye-type bearing axis and the eccentric unit bearing rotational axis. The eye-type bearing axis is eccentric relative to the crank rotational axis.

The guide element is allocated to a first guide element position in which the crank rotational axis, the eccentric unit bearing rotational axis and the guide element axis are all in one plane. The first guide element position coincides with a first crank position of the crank. The first guide element position, or the first crank position, refers, for example, to a front dead center at which the guide element axis exhibits the maximum deflection relative to the crank rotational axis. For example, a second guide element position is allocated to a rear dead center at which the guide element axis exhibits the smallest deflection relative to the crank rotational axis.

The eccentric unit is designed such that one revolution of the crank, i.e. a crank angle of 360° starting from the first crank position, will result in one orbit of the eye-type bearing axis around the crank rotational axis. According to this orbit, the distance between the eye-type bearing axis and the crank rotational axis changes within one revolution of the crank. The eccentric unit is designed such that the eccentricity of the eye-type bearing axis can be adjusted relative to the crank rotational axis.

According to the invention, the eccentric unit has a mechanical setting device comprising a setting element which latter acts on an eccentric element, with the setting device being designed such that the setting element can adopt different setting positions relative to the crank rotational axis, specifically position and/or orientation, and the setting element can be locked in this setting position, with a respective orbit of the eye-type bearing axis about the crank rotational axis being allocated to a setting position.

For the purpose of adjusting the eccentricity of the eye-type bearing axis relative to the crank rotational axis, the eccentric unit is provided with the mechanical setting device. The mechanical setting device uses mechanical components, bodies or parts that act on each other with forces, to adjust the eccentricity of the eye-type bearing axis relative to the crank rotational axis. The setting device comprises the setting element, which acts mechanically on the eccentric element so as to cause a mechanically generated movement of the eye-type bearing axis relative to the crank rotational axis.

The setting element can adopt different setting positions relative to the crank rotational axis. The setting position is the position and/or orientation of the setting element relative to the crank rotational axis. The position can be a distance, in particular a radial distance, of the setting element relative to the crank rotational axis. The orientation can be an angular rotation of the setting element about the crank rotational axis.

An orbit of the eye-type bearing axis about the crank rotational axis is allocated to a respective setting position of the setting element. Changing the setting position will change the orientation of the eye-type bearing axis relative to the eccentric unit bearing rotational axis, with respect to the first crank position, thus changing the course of the orbit, i.e. the distance between the eye-type bearing axis and the crank rotational axis. The change in the course causes a change in the first guide element position and/or the second guide element position of the guide element. The eccentric unit bearing is spaced at a fixed distance from the crank rotational axis, so that when the course is changed, the first guide element position and the second guide element position change, in particular by the same amount, thus causing the a stroke position of the displacement element to be adjusted without changing the stroke length. The setting position, and therefore the guide element position, can be set precisely and reproducibly thanks to the mechanical coupling.

The invention further provides for the setting element to be lockable in the desired setting position, in particular with a positive fit, resulting in the setting position remaining unchanged during rotation of the crank. This ensures that the first guide element position and the second guide element position and/or the stroke position of the displacement element are retained until the next time the setting position changes.

Since the setting element of the setting device is located at a position that does not rotate relative to the crank, the orbit of the eye-type bearing axis around the crank rotational axis can be changed in an advantageous manner both when the drive device is at a standstill and during operation.

In a preferred embodiment of the invention, the eccentric element is attached to the crank via the eccentric unit bearing so as to be rotatable about the eccentric unit bearing rotational axis, with the eye-type bearing being connected to the eccentric element such that the eye-type bearing axis is mounted at a constant distance for rotation about the eccentric unit bearing rotational axis. The design with an eccentric element with mutually offset axes of rotation allows simple adjustment of the eye-type bearing axis on the orbit about the crank rotational axis by rotating the eccentric element around the eccentric unit bearing rotational axis. Rotating the crank about the crank rotational axis can cause the eccentric element to rotate relative to the crank. This allows the eccentric element to move about both the crank rotational axis and the eccentric unit bearing rotational axis within one revolution of the crank. A change in the orientation of the eccentric element by the setting element will affect the course of the eccentricity of the eye-type bearing axis relative to the crank rotational axis.

Preferably, the eccentric unit has an adjusting device which is operatively connected to the setting element in such a way that actuation of the adjusting device changes the position of the eye-type bearing axis at an allocated crank angle relative to the crank rotational axis, with the adjusting device further comprising a locking device which locks the setting element in the setting position, in particular in a positive-locking manner. The change in the eye-type bearing axis relative to the crank rotational axis over a crank angle of 360° starting from the first crank position is the orbit. The orbit can be changed by changing the position and/or the orientation of the setting element relative to the crank rotational axis using the adjusting device.

Preferably, the adjusting device includes a drive structure for accommodating a rotary movement. The adjusting device can be connected to a drive via the drive structure. The drive enables the rotary movement of the adjusting device, which can change the position and/or the orientation of the setting element. As a result, the setting element acts mechanically on the eccentric element to adjust the eccentricity of the eye-type bearing axis in relation to the crank rotational axis.

Preferably, the adjusting device comprises a motor, in particular an electric motor, which is connected to the drive structure. It is also conceivable for the drive device to include a hydraulic motor. The adjustment of the position and/or the alignment of the setting element can be easily automated.

In a particularly preferred embodiment of the invention, the adjusting device has a control unit that in particular controls the motor. This allows the setting position of the setting element to be set automatically.

In yet another embodiment of the invention, the control device has a memory unit which stores a set of operating parameters, for example of a rolling process, so that, as a function of the set of parameters, an allocated setting position of the setting element can be set by controlling the motor. This makes it quick and easy to set the setting element, for example as a function of product parameters. The stored setting positions of the setting element thus allow an adjustment of the setting element in an advantageous way without any sensors by using the motor control method, which adjustment can also be repeated reproducibly.

Preferably, the adjusting device comprises an adjusting gear which is designed as a self-locking gear unit. This means that setting and locking the setting element can be carried out using the same gear unit. The setting position can be adjusted by driving the gear unit. If the gear unit is not under any load, the setting element is prevented from resetting, which means that it is locked in the adjusted setting position. The adjusting gear is resistant to loosening, e.g. slipping or twisting, and forms the locking device that locks the setting element in the setting position.

In a preferred embodiment of the invention, the adjusting gear comprises a threaded screw element that acts between the drive structure and the setting element, which thread is designed to be self-locking. The threaded screw element and the setting element can be part of a gear unit, and in particular are in direct engagement with one another. Adjusting the screw element will change the setting position, i.e. the position and/or the orientation of the setting element relative to the crank rotational axis. Such a design can reliably prevent resetting, e.g. due to slipping or twisting of the setting element, because it results in a positive connection between the gear teeth, which also causes the setting element to be held in its setting position by a positive fit. The adjusting device can be used to set the position and/or the orientation of the setting element and to fix the position and/or the orientation. Setting and locking are thus advantageously achieved using the same device.

In a preferred embodiment of the invention, the eccentric element is designed as a gear, and the setting element is designed as a central gear, which central gear is mounted coaxially to the adjusting gear and is mounted for rotation about the crank rotational axis via the adjusting gear and can be locked in position via the adjusting gear. In its locked state, the central gear will then interact with the gear so as to cause the gear to rotate relative to the crank when the crank is rotated, with the eye-type bearing axis thus being moved around the eccentric unit bearing axis.

The orientation of the central gear relative to the crank rotational axis is set via an angular rotation of the central gear around its rotational axis, which is coaxial to the crank rotational axis. The central gear acts mechanically on the gear that is coaxial to the eccentric unit bearing rotational axis and firmly connected to the eye-type bearing, so as to turn the latter gear as well. This will adjust the eye-type bearing. Such adjustment is accompanied by a change in the position of the eye-type bearing axis in relation to the eccentric unit bearing rotational axis.

The eccentricity of the eye-type bearing axis is thus adjusted in relation to the crank rotational axis, and the orbit of the eye-type bearing axis around the crank rotational axis is changed. This results in a change of the first guide element position and of the second guide element position in the guide direction, and allows the stroke position of the displacement element to be adjusted.

The central gear is mounted in such a way that the crank can rotate and the central gear is fixed in position, which central gear can be locked in the setting position by means of the adjusting device. The locked central gear interacts with the gear in such a way that rotation of the crank will cause the gear to rotate relative to the crank. Preferably, when the crank is turned, the gear rolls directly off the central gear.

In another embodiment of the invention, the adjusting gear can be designed as a worm gear comprising a worm wheel which is non-rotatably connected to the central gear, with the threaded screw element comprising a worm shaft which engages with the worm wheel. The thread turn of the worm shaft engages with the tooth gaps of the worm gear. Such a worm gear has a high load capacity. The presence of the worm gear results in a high resistance to slipping or twisting of the worm shaft and the worm wheel, which are in contact with each other. This locks the central gear, which meshes with the worm gear, in its setting position.

When adjusting the setting element or the central gear, the worm gear can easily be adjusted equally in both directions of rotation. Turning the central gear around the crank rotational axis turns the gear wheel, which in turn causes the eye-type bearing to be adjusted and, as a result, the first and second guide element positions are realized. This allows the eye-type bearing axis to be continuously adjusted relative to the crank rotational axis, by continuously turning the fixed central gear, in order to achieve an exact adjustment of the first position of the guide element or of the movable displacement element with a high degree of precision.

Preferably, the central gear and the gear are designed to have the same number of teeth. After one rotation of the eccentric unit bearing around the crank rotational axis, the eye-type bearing axis will thus be back at its starting point. As a result, the stroke length of the guide element or of the guide element axis remains unchanged.

In a preferred embodiment of the invention, the eccentric element is a lever that can be pivoted about the eccentric unit bearing rotational axis by a pivoting angle. On the lever, the eye-type bearing axis is arranged eccentrically to the eccentric unit bearing pivot axis. Depending on the pivoting angle of the lever, the position of the eye-type bearing axis relative to the crank rotational axis therefore changes, with the pivoting movement of the lever being accomplished by a link motion system. The link motion system includes the setting element. The link motion system enables a curved track to be implemented based on the rotation of the crank, depending on the position of the setting element.

In an advantageous further embodiment of the invention, the link motion system is implemented such that the setting element is a link block that can be rotated relative to the crank about a rotational axis parallel to the crank rotational axis. The motion link is made along the lever, particularly in the form of a slotted hole. As a result, the pivoting angle of the lever changes over one revolution depending on the distance, in particular the radial distance, of the link block from the crank rotational axis.

The adjusting device is designed in such a way that the link block can be locked in place at an adjustable distance from the crank rotational axis. This ensures good reproducibility of the adjustment and good torque support.

Changing the position of the link block relative to the crank rotational axis will cause the pivoting angle range of the lever to change relative to the eccentric unit bearing, resulting in a shift of the eccentricity of the eye-type bearing axis relative to the crank rotational axis. This shifts the deflection of the connecting rod, and also shifts the first guide element position and the second guide element position in the guide direction and thus also the stroke position of the displacement element.

Preferably, the adjusting gear is a spindle gear that is connected to the link block. The spindle gear comprises a self-locking screw element which is connected to the link block in such a way that the distance, in particular the radial distance, of the link block from the crank rotational axis can be changed when the spindle gear is actuated. The link block can be adjusted in its position along a sliding axis of the spindle gear. Using the self-locking screw element, the position of the link block can be fixed at a distance from the crank rotational axis.

In a preferred embodiment of the invention, the spindle gear has a spindle axis that is orthogonal to the crank rotational axis. Changing the position of the link block changes the distance between the link block and the crank rotational axis.

In a preferred embodiment of the invention, the adjusting device comprises a locking device that fixes the setting element in a setting position. The locking device can, for example, guide the setting element when adjusting the setting position and then lock the setting element in place once the setting position has been reached.

In another aspect of the invention, a device for producing threads and profiles on blanks comprises a rolling die arrangement which has a stationary rolling die and a movable rolling die, which dies are guided parallel to one another in a guide direction, wherein the movable rolling die is connected to a drive device that produces a translatory movement of the movable rolling die relative to the stationary rolling die, and wherein the drive device has an adjustable eccentric unit for the orientation of the movable rolling die relative to the stationary rolling die.

The movable rolling die and the stationary rolling die each have a rolling profile. The drive device can be used to generate a linear back and forth movement of the movable rolling die relative to the stationary rolling die arranged in parallel thereto. The drive device has an adjustable eccentric unit for the precise alignment of the two rolling dies with one another.

According to the invention, the drive device is designed in the manner described above. The drive device comprises a connecting rod which has a connecting rod eye at a first end thereof and a guide element at a second end thereof. The guide element has a guide element axis and has the movable rolling die mounted directly or indirectly on it in such a way that the guide element axis, and thus the movable rolling die, executes a linear movement in the guide direction.

The drive device further comprises a crank, which is designed in particular as a crank arm or a crank wheel and which is mounted so that it can rotate about a crank rotational axis.

The eccentric unit of the drive unit is connected via an eye-type bearing, which has an eye-type bearing axis, to a connecting rod eye of a connecting rod that can rotate about the eye-type bearing axis.

Furthermore, the eccentric unit has an eccentric unit bearing that defines an eccentric unit bearing rotational axis. The eccentric unit is mounted on the crank via the eccentric unit bearing.

The rotational axis of the eccentric unit bearing is at a fixed distance from the crank rotational axis. Rotation of the eccentric unit about the eccentric unit bearing rotational axis results in an orbit of the eye-type bearing axis about the crank rotational axis, according to which the distance of the eye-type bearing axis from the crank rotational axis changes within one revolution of the crank. The eccentricity of the eye-type bearing axis relative to the crank rotational axis can be adjusted by means of the eccentric unit.

For this purpose, the eccentric unit has a mechanical setting device comprising a setting element that acts mechanically on an eccentric element. The setting element can adopt different setting positions relative to the crank rotational axis, namely position and/or orientation, wherein the setting position of the setting element can be locked in place, in particular in a positive-locking manner. An orbit each of the eye-type bearing axis about the crank rotational axis is allocated to a setting position, and, as a result, a change in the course of the orbit causes a change in the position of the guide element. This allows the stroke position of the movable rolling die to be set. This means that an initial position, which the movable rolling die holds before it is moved relative to the stationary rolling die by one stroke, can be changed in the guide direction without actually changing the stroke length. The drive device according to the invention allows the orientation of the movable rolling die relative to the stationary rolling die to be set with great precision and to be easily adjusted, so that high-quality threads can be manufactured reproducibly.

The setting element can be locked in the desired setting position, in particular in a positive-locking manner, so that the setting position remains unchanged during rotation of the crank. This ensures that the stroke position of the movable rolling die is maintained until the next time the setting position is changed.

The setting element is in a position where it does not rotate relative to the crank. This is an advantageous way of changing the orbit of the eye-type bearing axis around the crank rotational axis both when the device is at a standstill and during operation.

The further embodiments detailed in the description of the drive device according to the invention may also apply to the device for producing threads and profiles.

Additional advantages, features and possible applications of the present invention will become apparent from the description which follows, in which reference is made to the embodiments illustrated in the drawings.

In the drawings,

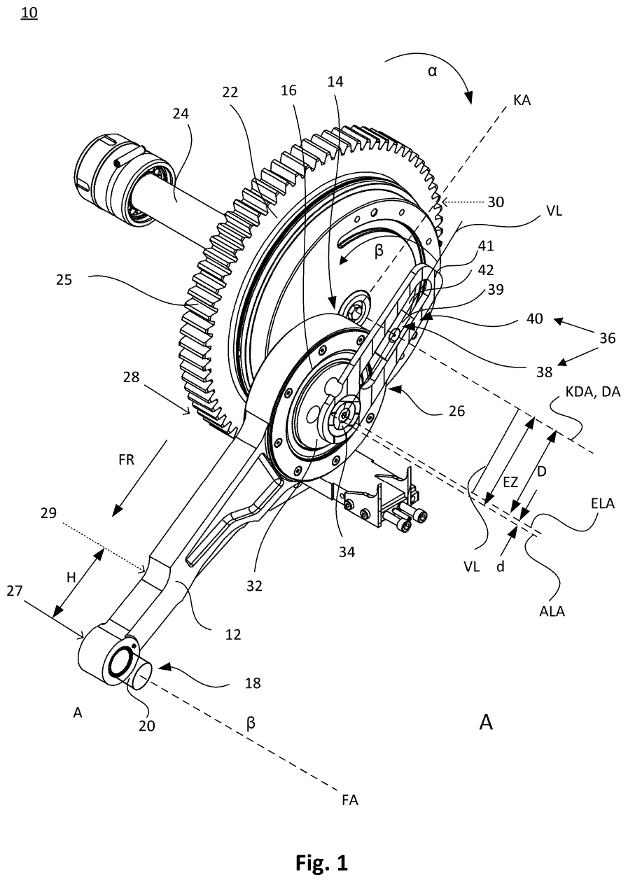

FIG. 1 is a perspective view of a first embodiment of a drive device according to the invention;

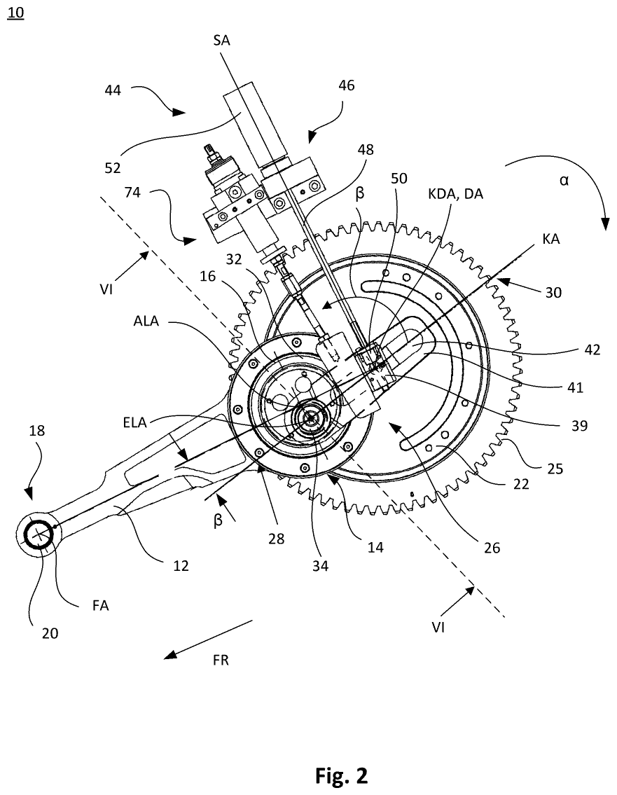

FIG. 2 is a lateral view of a first embodiment of a drive device according to the invention;

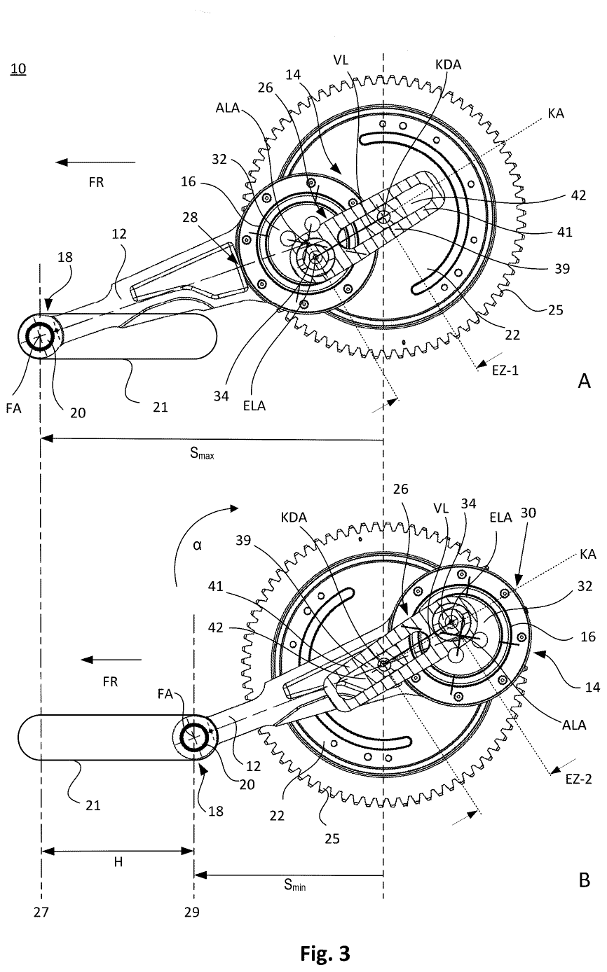

FIG. 3 is a view of a first embodiment of a drive device in different operating positions thereof;

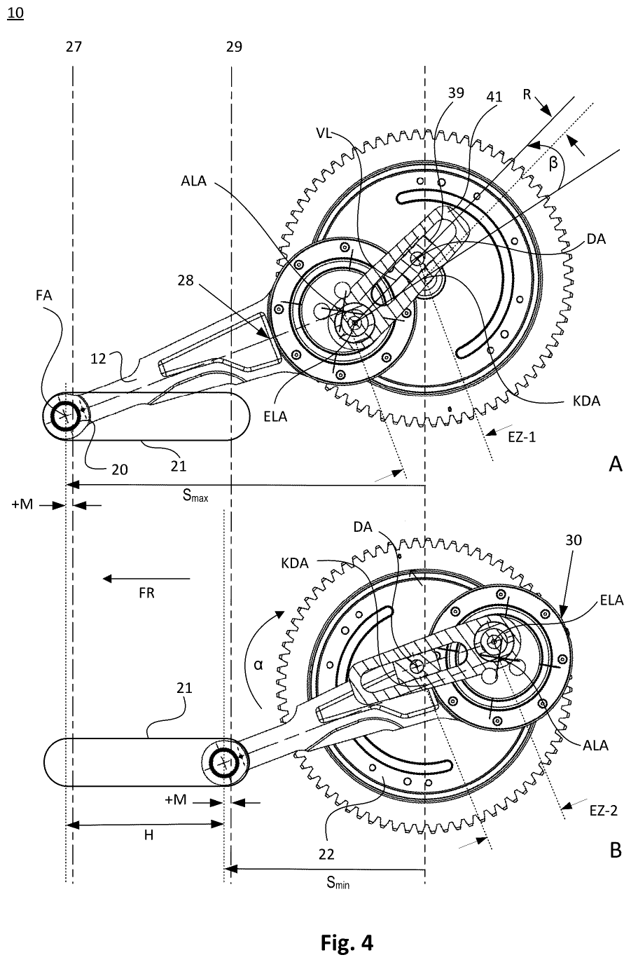

FIG. 4 is a view of a first embodiment of a drive device with an adjusted setting element and in different operating positions each;

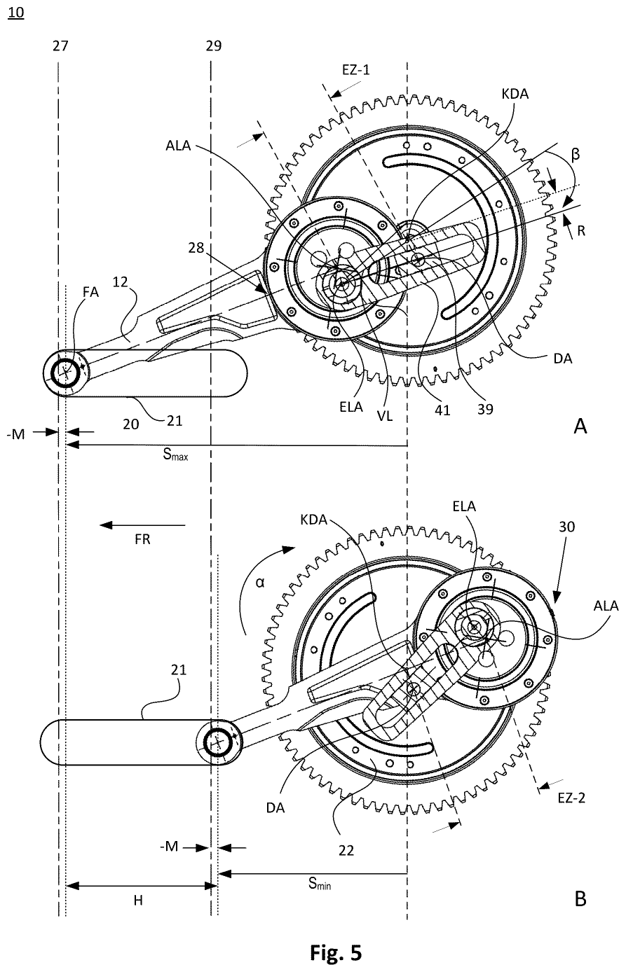

FIG. 5 is a view of a first embodiment of a drive device with an adjusted setting element and in different operating positions each;

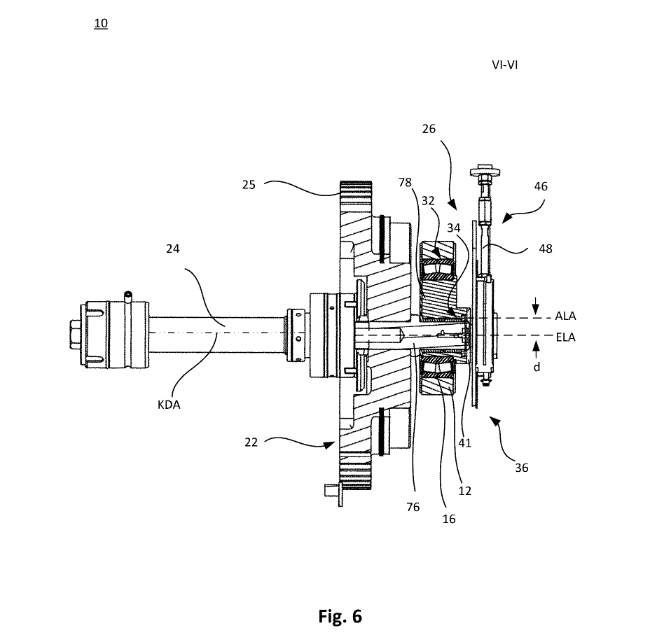

FIG. 6 is a sectional view of the drive device of FIG. 2;

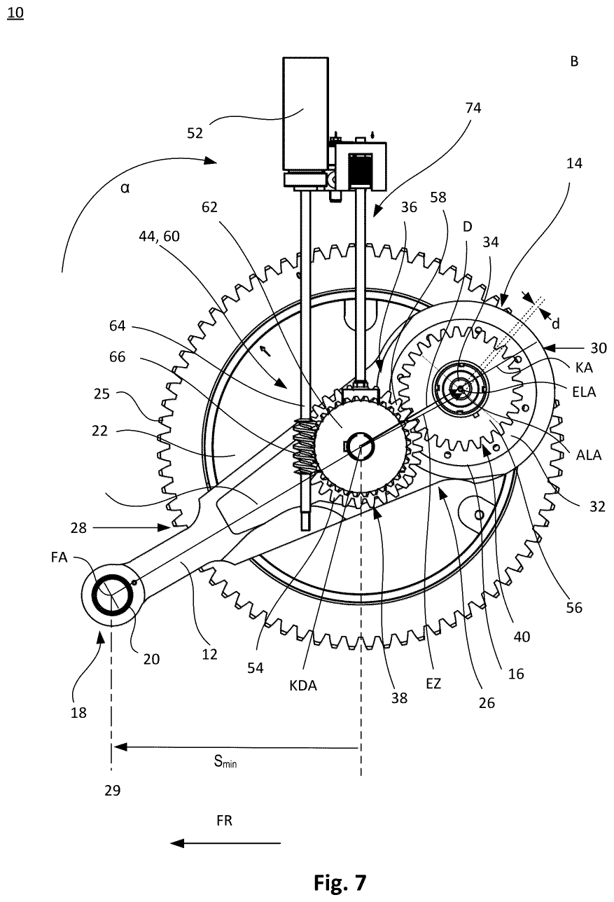

FIG. 7 is a lateral view of a second embodiment of a drive device according to the invention;

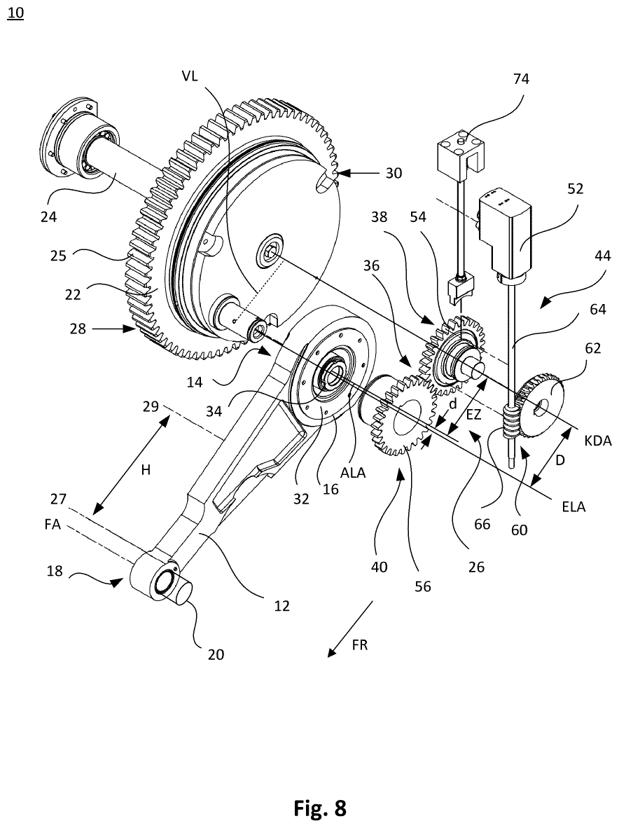

FIG. 8 is an exploded view of the drive device of FIG. 7;

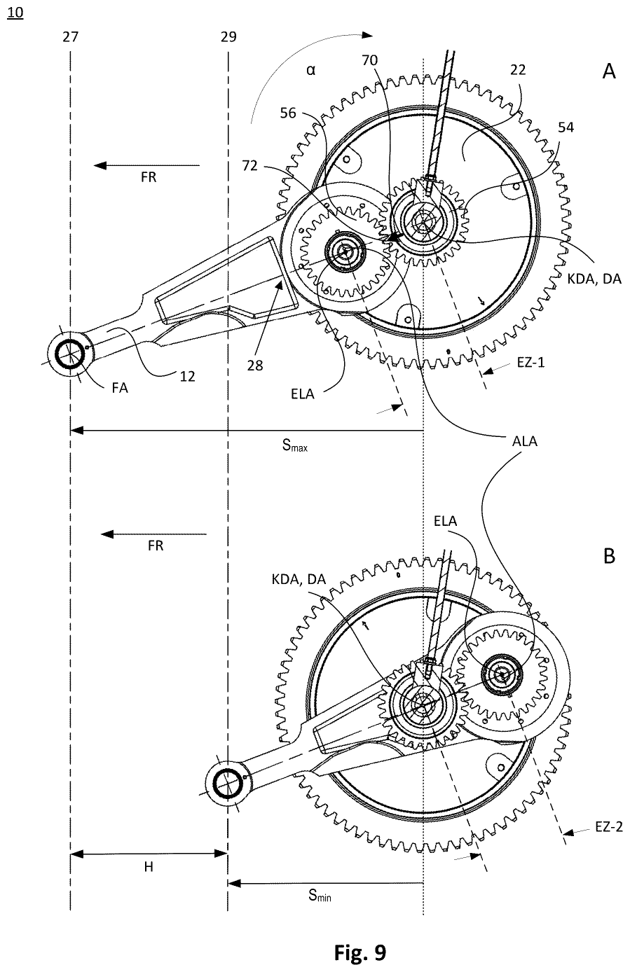

FIG. 9 is a view of a second embodiment of a drive device in different operating positions thereof;

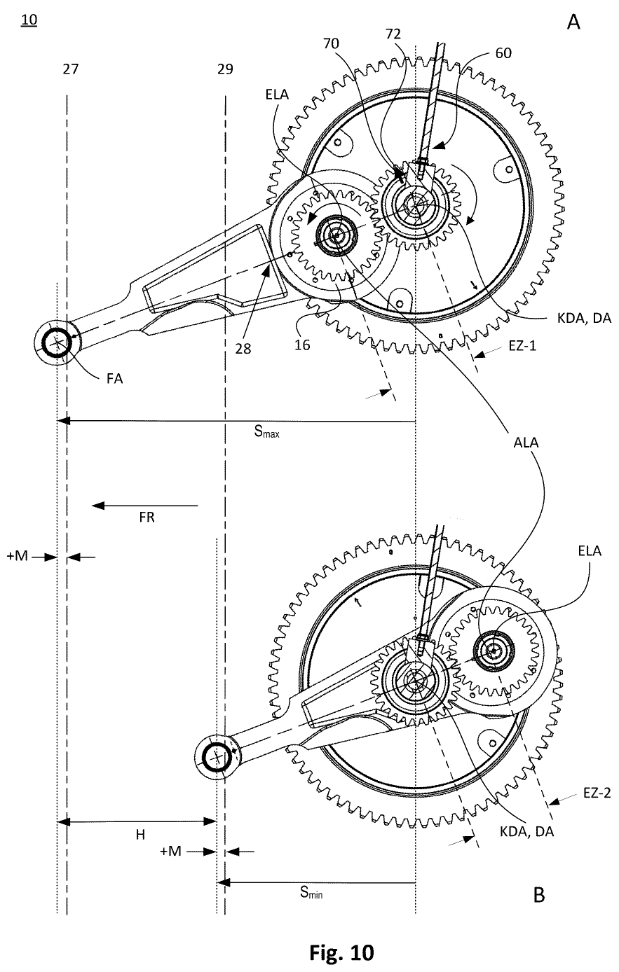

FIG. 10 is a view of a second embodiment of a drive device with an adjusted setting element and in different operating positions each; and

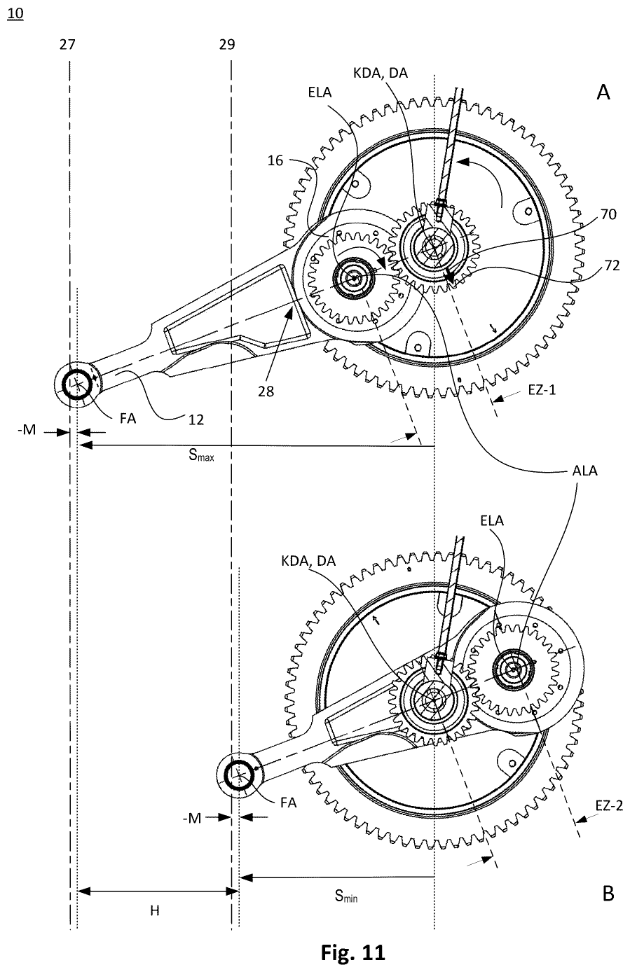

FIG. 11 is a view of a second embodiment of a drive device with an adjusted setting element and in different operating positions each.

FIG. 1 to FIG. 11 are schematic views each of a drive device according to the invention, designated overall by the reference signs 10, for the output movement of a displacement element.

FIG. 1 is a perspective view of a first embodiment of a drive device 10 according to the invention. The drive device 10 has a connecting rod 12, which has a connecting rod eye 16 at a first end 14 thereof and a guide element 20 at a second end 18 thereof, which is directly or indirectly connected, for example by means of a linkage or the like, to a movable displacement element (not shown here). In particular, the displacement element can be a movable rolling die of a thread rolling machine.

In particular, the guide element 20 is mounted such that it can rotate and/or pivot about a guide element axis FA. The guide element 20 is mounted in such a way that it essentially performs a translatory movement in a guide direction FR that is orthogonal to the guide element axis FA.

The drive device 10 comprises a crank 22, which in the present case takes the form of a crank wheel. The crank 22 is mounted via a bearing axis 24 on a housing (not shown), for example of a thread rolling machine. The crank 22 is mounted for rotation about a crank rotational axis KDA and has a crank axis KA that is orthogonal to the crank rotational axis KDA. The crank axis KA can rotate about the crank rotational axis KDA, thereby sweeping through a crank angle α. In the present case, the crank 22 has drive structures 25 in the form of external teeth, which can be used to drive the crank 22.

The drive device 10 further has an eccentric unit 26, which is connected to the connecting rod eye 16 via an eye-type bearing 32, which has an eye-type bearing axis ALA. The connecting rod eye 16 is arranged to rotate about the eye-type bearing axis ALA.

The eccentric unit 26 is connected to the crank 22 via an eccentric unit bearing 34. The eccentric unit bearing 34 has an eccentric unit bearing rotational axis ELA about which it can rotate. The eccentric unit bearing rotational axis ELA is arranged at a fixed distance D from the crank rotational axis KDA. The distance D is greater than a distance d between the eye-type bearing axis ALA and the eccentric bearing rotational axis ELA. The eye-type bearing axis ALA has an eccentricity EZ relative to the crank rotational axis KDA.

When the crank 22 rotates, a connecting line VL, which connects the crank rotational axis KDA with the eccentric unit bearing rotational axis ELA and is orthogonal to the crank rotational axis and to the eccentric unit bearing rotational axis ELA, pivots about the crank rotational axis KDA.

The present view shows the drive device 10 in an operating position A, which indicates a front dead center of the crank 22, in which the crank rotational axis KDA, the eye-type bearing axis ALA and the guide element axis FA are in one plane, and the guide element axis FA has the greatest deflection Sₘₐₓ relative to the crank rotational axis KDA. In conjunction with the front dead center, a first guide element position 27 is allocated to the guide element 20, and a first crank position 28 of the crank 22 is allocated to the crank 22.

If the crank 22 sweeps through a crank angle of 180° starting from the first crank position 28, a second crank position 30 is allocated to the crank 22, which coincides with a rear dead center of the crank 22, as is described with reference to FIG. 3 through FIG. 5. Along with the second crank position 30, a second guide element position 29 is allocated to the guide element 20, in which the guide element axis FA has the smallest deflection Sₘᵢₙ relative to the crank rotational axis KDA and the drive device 10 adopts the operating position B. An extent between the first guide element layer 27 and the second guide element layer 29 corresponds to a stroke length H of the displacement element connected to the guide element 20.

The eccentric unit 26 is designed such that, in relation to one revolution of the crank 22, starting, for example, from the first crank position 28, an orbit of the eye-type bearing axis ALA around the crank rotational axis KDA results. According to the orbit, the eccentricity EZ of the eye-type bearing axis ALA with respect to the crank rotational axis KDA changes within one revolution of the crank 22.

The eccentricity EZ of the eye-type bearing axis ALA relative to the crank rotational axis KDA can be set. For this purpose, the eccentric unit 26 has a mechanical setting device 36, which has a setting element 38 that exerts mechanical forces on an eccentric element 40. In the present embodiment of the drive device 10, the setting element 38 is designed as a link block 39 and the eccentric element 40 is designed as a lever 41.

The lever 41 can be pivoted about the eccentric unit bearing rotational axis ELA by a pivoting angle β, and pivots the eye-type bearing axis ALA about the eccentric unit bearing rotational axis ELA. The pivoting movement of the lever 41 is realized by a link motion system, which includes the link block 39. The link block 39 is adapted to be rotated relative to the crank 22 about a rotational axis DA, which in the present case is coaxial with the crank rotational axis KDA, with the link block 39 being accommodated in a motion link 42, which in the present case is formed as a slotted hole along the lever 41. Changing the position of the link block 39 relative to the crank rotational axis KDA results in a change of a pivoting angle range of the lever 41, see FIG. 4.

Owing to the rotation of the crank 22, the link motion system results in an orbit of the eye-type bearing axis ALA around the crank rotational axis KDA, which can change depending on the pivoting angle range of the lever 41, which pivoting angle range can in turn be adjusted by changing the position of the link block 39 relative to the crank rotational axis KDA.

This means that the rotation of the eye-type bearing axis ALA around the crank rotational axis KDA can be changed depending on the distance, in particular the radial distance, of the link block 39 from the crank rotational axis KDA. Each setting position of the link block 39 is allocated to an orbit of the eye-type bearing axis ALA around the crank rotational axis KDA.

For adjusting the position of the link block 39, the eccentric unit 26 has an adjusting device 44 (not shown here), which is described in more detail with reference to FIG. 2.

FIG. 2 is a lateral view of the first embodiment of the drive device 10. The eccentric unit 26 has the adjusting device 44, which is operatively connected to the link block 39 and which can be used to adjust a position of the link block 39 relative to the crank rotational axis KDA.

In the present view, the adjusting device 44 comprises a spindle gear 46 consisting of a spindle 48 and a self-locking screw element 50. The spindle 48 has a spindle axis SA that is orthogonal to the crank rotational axis KDA.

The screw element 50 is connected to the link block 39, which is mounted to rotate about a rotational axis DA that is coaxial with the crank rotational axis KDA in the present case. When the crank axis KA sweeps through a crank angle α, the link block 39 rotates about its rotational axis DA and the lever 41 pivots about the rotational axis DA, with the lever 41 sweeping through a pivot angle β starting from the connecting line VL, which connects the crank rotational axis KDA to the eccentric unit bearing rotational axis ELA. The guide element axis FA performs a linear movement in the guide direction FR.

The setting position of the link block 39 can be changed by actuating the spindle gear 46 of the adjusting device 44. The adjusting device 44 has a drive structure for accommodating a rotary movement, which latter is connected to a motor 52, in particular an electric motor. The motor 52 causes the spindle 48 to rotate, thus allowing adjustment of a position of the screw element 50 in both directions along the spindle axis SA of the spindle 48. The screw element 50 is fixed in place in the setting position by a locking device 74. In the present case, the locking device 74 is adapted to provide linear guidance of the screw element 50.

The adjusting device 44 can therefore change the setting position of the link block 39 by adjusting the distance, in particular the radial distance, of the link block 39 which is rotatably connected to the screw element 50, from the crank rotational axis KDA, see also FIG. 4. This changes the pivoting angle β relative to the connecting line VL and thus the pivoting angle range of the lever 41, which in turn changes the orbit of the eye-type bearing axis ALA around the crank rotational axis KDA. As a result, the first guide element position 27 and the second guide element position 29, and the stroke of the displacement element have been changed.

In particular, the screw element 50 is of a self-locking design, so that the position of the link block 39 can be positively locked at a distance from the crank rotational axis KDA, with the setting position remaining unchanged during rotation of the crank 22. This ensures that the first guide element position 27 and the second guide element position 29 will be retained until the next time the setting position changes.

The adjusting device 44 can further have a control device which, in particular, controls the motor 52. This means that the setting position of the link block 39 can be adjusted automatically. The control device can, for example, access a memory unit which stores a set of operating parameters, e.g. of a rolling process. Depending on the set of parameters, an allocated setting position of the link block 39 can be set by controlling the motor 52. Because the setting positions of the link block 39 are stored, the link block 39 can be repeatedly adjusted in a quick, easy and reproducible manner using the control method of the motor 52. Advantageously, the adjustment can be performed without the use of sensors.

FIG. 3 is a lateral view of the inventive drive device 10 of FIG. 1 in different operating positions A, B, which correspond to the front dead center and the rear dead center of the crank 22, respectively. In this view, the respective crank rotational axes KDA are arranged in alignment. In both operating positions A, B, the link block 39 maintains a neutral setting relative to the crank rotational axis KDA, in which its rotational axis DA is coaxial with respect to the crank rotational axis KDA. In the neutral setting position, the link block 39 rotates around the crank rotational axis KDA in the motion link 42 of the lever 41.

Along with the front dead center of the operating position A, the guide element axis FA has the largest deflection Sₘₐₓ in relation to the crank rotational axis KDA. The guide element 20, which in the present view is seen to be guided in a guide 21, is allocated to the first guide element position 27, and the crank 22 is allocated to the first crank position 28.

When the crank 22 rotates one revolution, starting from the first crank position 28, the link block 39 rotates about its rotational axis DA, which in the present view is coaxial with respect to the crank rotational axis KDA. The connecting line VL, which connects the crank rotational axis KDA with the eccentric unit bearing rotational axis ELA and is orthogonal with respect to the crank rotational axis KDA and the eccentric unit bearing rotational axis ELA, pivots around the crank rotational axis KDA. Control by the link motion system results in an orbit of the eye-type bearing axis ALA around the crank rotational axis KDA, which corresponds to the eccentricity EZ of the eye-type bearing axis ALA relative to the crank rotational axis KDA. At the front dead center the eccentricity is designated EZ-1, and at the rear dead center it is designated EZ-2.

At a crank angle α of 180° starting from the first crank position 28, the operating position B has been reached, which coincides with the rear dead center and the allocated second crank position 30 of the crank 22. The guide element 20 has been moved in the guide direction FR over a stroke length H from the first guide element position 27 to the second guide element position 29, which has the smallest deflection Sₘᵢₙ of the guide element axis FA relative to the crank rotational axis KDA.

In the present neutral setting position of the link block 39, the eye-type bearing axis ALA is at the same distance from the crank rotational axis KDA both at the front dead center and at the rear dead center. In this orbit, which is allocated to the neutral setting position, the eccentricity EZ-1 and EZ-2 are of the same extent.

The orbit of the eye-type bearing axis ALA around the crank rotational axis KDA and/or the eccentricity EZ of the eye-type bearing axis ALA relative to the crank rotational axis KDA can be adjusted by changing the pivoting angle range of the lever 41. The pivoting angle range can be adjusted by changing the position of the link block 39 relative to the crank rotational axis KDA. This is achieved using the adjusting device 44 described with reference to FIG. 2. The spindle 48 of the adjusting device 44 can be rotated in both directions. This makes it possible to change the position of the link block 39 relative to the crank rotational axis KDA in the axial direction of the spindle 48. This means that the position of the link block 39 can be adjusted in such a way that its rotational axis DA can be moved parallel to the crank rotational axis KDA in one direction, see FIG. 4, and in the respective other direction along the spindle 48, see FIG. 5.

FIG. 4 is a view of the drive device 10 with a changed setting position of the link block 39 relative to the neutral setting position shown in FIG. 3. The crank 22 is shown in the respective operating positions A, B corresponding to the front dead center and the rear dead center, respectively, with the respective crank rotational axes KDA being aligned.

As a result of a linear adjustment of the screw element 50 along the spindle axis SA, in particular in an upward direction, the link block 39 connected to the screw element 50 is adjusted in its position relative to the neutral setting position, see FIG. 3. As a result, the rotational axis DA of the link block 39 is arranged at a distance R, in particular a radial distance, from the crank rotational axis KDA. The changed setting position of the link block 39 relative to the neutral setting position causes the link motion system to change. As a result, the lever 41, which can be pivoted about the eccentric unit bearing rotational axis ELA, is rotated counterclockwise by a pivot angle β starting from the connecting line VL, compare FIG. 3 with FIG. 4.

Depending on the change in the pivoting angle β, the connecting rod eye 16 rotates around the eye-type bearing 32, and the eye-type bearing axis ALA, which is arranged eccentrically to the eccentric bearing rotational axis ELA on the lever 41, shifts relative to the crank rotational axis KDA. This changes the eccentricity EZ of the eye-type bearing axis ALA relative to the crank rotational axis KDA and thus the orbit of the eye-type bearing axis ALA around the crank rotational axis KDA. In the present case, the orbit is changed in such a way that the eccentricity EZ-1 at the front dead center is greater than that of the neutral setting position, compare operating position A in each of FIG. 3 and FIG. 4.

As a result, the first guide element position 27 allocated to the neutral setting position of the link block 39 changes relative to the crank rotational axis KDA. The maximum deflection Sₘₐₓ of the guide element axis FA shifts by an extent M in the guide direction FR. This means that the stroke position of the displacement element (not shown here) has been shifted by an extent M in the guide direction FR.

Starting from the first crank position 28 at a crank angle α of 180°, the crank 22 reaches the operating position B which coincides with the rear dead center. The change in the orbit of the eye-type bearing axis ALA around the crank rotational axis KDA means that the eccentricity EZ-2 at the rear dead center is now smaller than the eccentricity EZ-1 at the front dead center, compare operating position A with operating position B.

In the operating position B, the guide element axis FA has the smallest deflection Sₘᵢₙ in relation to the crank rotational axis KDA. Because the distance between the eccentric bearing rotational axis ELA and the rotational axis DA of the link block 39 remains constant as the crank 22 rotates, the stroke length H, over which the guide element 20 can be moved, is also constant. As a result, the smallest deflection Sₘᵢₙ of the guide element axis FA to the crank rotational axis KDA is changed by the same extent M in the guide direction FR relative to the second guide element position 29 of the neutral setting position, compare the operating position B of FIG. 3 and FIG. 4 each. This means that the stroke position of the displacement element can be adjusted without adjusting the stroke length.

As seen in FIG. 5, the link block 39 of the drive device 10 has been moved by the same distance R relative to the crank rotational axis KDA in the other direction along the spindle axis SA, in particular downwards, see FIG. 3 and FIG. 5. The rotational axis DA of the link block 39 is arranged parallel to and at a distance from the crank rotational axis KDA, and at the front dead center starting from the connecting line VL, the lever 41 has been moved counterclockwise about the eccentric unit bearing rotational axis ELA by the pivoting angle β.

Along with the change in the position of the link block 39, the alignment of the eye-type bearing axis ALA relative to the eccentric bearing axis ELA, and thus the eccentricity EZ relative to the crank rotational axis KDA, has been changed. The orbit of the eye-type bearing axis ALA around the crank rotational axis KDA is changed in such a way that the eccentricity EZ-1 at the front dead center is now less than the eccentricity EZ-2 at the rear dead center, compare operating position A and operating position B. Analogously, the respective deflections Sₘₐₓ and Sₘᵢₙ of the guide element axis FA relative to the crank rotational axis KDA in the respective operating positions A, B in the guide direction FR are reduced by the same extent M in each case compared to the first guide element position 27 and second guide element position 29, which are allocated to the neutral setting position of the link block 39. This results in an overall adjustment of the stroke position of the displacement element without changing the stroke length.

A respective setting position of the link block 39 is therefore allocated to a respective stroke position of a displacement element connected to the guide element 20. The stroke position of the displacement element can be adjusted by the extent M, in particular between 0 mm and 10 mm, continuously and precisely with high reproducibility by mechanically setting the setting position of the link block 39 relative to the crank rotational axis KDA.

FIG. 6 is a sectional view, taken along lines VI-VI, of the drive device 10 of FIG. 2. The drive device 10 comprises the crank 22, which is connected to a housing (not shown here) via the bearing axis 24 and has drive structures 25, via which it can be driven. The crank 22 rotates around the crank rotational axis KDA.

Furthermore, the drive device 10 includes the eccentric unit 26 which comprises the eye-type bearing 32 and the eccentric unit bearing 34.

The eccentric unit 26 is mounted on a bearing journal 76 of the crank 22 via the eccentric unit bearing 34. The eccentric unit bearing 34 defines the eccentric unit bearing rotational axis ELA, which is arranged at a fixed distance D from the crank rotational axis KDA, see FIG. 2. When the crank 22 rotates, the eccentric unit rotational axis ELA rotates around the crank rotational axis KDA.

The eccentric unit 26 is connected to the connecting rod eye 16 of the connecting rod 12 via the eye-type bearing 32 which defines the eye-type bearing axis ALA. The connecting rod eye 16 can be rotated about the eye-type bearing axis ALA. In the present case, the eye-type bearing 32 comprises an eccentric disk 78, which is non-rotatably connected to the lever 41. The eye-type bearing axis ALA is fixed to the lever 41 and spaced at a distance d from the eccentric unit bearing rotational axis ELA, with the lever 41 being arranged so that it can pivot around the eccentric unit rotational axis ELA.

Changing the pivoting angle β of the lever 41 about the eccentric unit bearing rotational axis ELA will cause the lever 41 to entrain in its rotation the eccentric disk 78 attached to it, which results in a change of the position of the eye-type bearing axis ALA relative to the eccentric unit bearing rotational axis ELA and of the eccentricity EZ relative to the crank rotational axis KDA.

FIG. 7 is a lateral view of a second embodiment of the drive device 10 according to the invention. It comprises a connecting rod 12, which has a connecting rod eye 16 at a first end 14 thereof and a guide element 20 at a second end 18 thereof, which guide element 20 is in particular mounted such that it can rotate and/or pivot about a guide element axis FA and which is connected to a movable displacement element (not shown here), in particular a movable rolling die.

The drive device 10 comprises a crank 22, which is mounted such that it rotates about a crank rotational axis KDA. The crank 22 can be driven via external drive structures 25, in particular teeth. The crank 22 has a crank axis KA, which is orthogonal to the crank rotational axis KDA and which can rotate about the crank rotational axis KDA. During this rotation, the crank axis KA sweeps through a crank angle α, and the guide element axis FA performs an essentially linear movement in the guide direction FR.

In the present view, the crank 22 is seen in an operating position B, which coincides with a rear dead center of the crank 22 and in which the guide element axis FA has the smallest deflection Sₘᵢₙ relative to the crank rotational axis KDA.

In conjunction with the front dead center and the rear dead center, at which the crank rotational axis KDA, the eccentric unit bearing rotational axis ELA and the guide element axis FA are all in one plane, a first crank position 28 and a second crank position 30 each are allocated to the crank 22.

The drive device 10 has an eccentric unit 26, which is connected to the crank 22 via an eccentric unit bearing 34. The eccentric unit bearing 34 has an eccentric unit bearing rotational axis ELA around which it can rotate. The eccentric bearing rotational axis ELA is arranged at a fixed distance D from the crank rotational axis KDA.

The eccentric unit 26 is connected to the connecting rod eye 16 via an eye-type bearing 32, which has an eye-type bearing axis ALA and which is arranged to rotate about the eye-type bearing axis ALA. The eye-type bearing axis ALA is arranged to rotate around the crank rotational axis KDA and the eccentric bearing rotational axis ELA. The eye-type bearing axis ALA is spaced at a distance d from the eccentric bearing rotational axis ELA and is eccentric with respect to the crank rotational axis KDA.

The eccentric unit 26 has a mechanical setting device 36, which comprises a setting element 38 designed as a central gear 54, which is operatively connected via meshing external teeth 58 to an eccentric element 40 designed as a gear 54.

The central gear 54 can be rotated around, and is arranged coaxially to, the crank rotational axis KDA. The central gear 54 is mounted such that the crank 22 can rotate and the central gear 54 is fixed in position. When the crank 22 rotates, the gear 56 rotates relative to the crank 22 and rolls directly off the central gear 54. Starting from the first crank position 28, for example, this results in an orbit of the eye-type bearing axis ALA around the crank rotational axis KDA.

In order to adjust the eye-type bearing axis ALA relative to the crank rotational axis KDA, a setting position of the central gear 54 is changed relative to the crank rotational axis KDA. This is achieved by rotating the central gear 54 at an angle around the crank rotational axis KDA. For this purpose, the eccentric unit 26 has an adjusting device 44, which in the present second embodiment of the drive device 10 is designed as a worm gear 60. The worm gear 60 comprises a worm wheel 62, which is non-rotatably connected to the central gear 54, and a worm shaft 64, a threaded section 66 of which meshes with tooth gaps of the worm wheel 62. Axial adjustment of the worm shaft 64 can be effected by a motor 52. This results in an angular rotation of the worm wheel 62, and thus of the central gear 54. Changing the setting position of the central gear 54 results in an adjustment of the gear 56, which is firmly connected to the eye-type bearing 32.

The rotation of the gear 56 is accompanied by a rotation of the eye-type bearing axis ALA about the eccentric unit bearing rotational axis ELA. An eccentricity EZ of the eye-type bearing axis ALA changes relative to the crank rotational axis KDA, so that the orbit of the eye-type bearing axis ALA around the crank rotational axis KDA changes. The change in the eye-type bearing axis ALA shifts a deflection Sₘᵢₙ of the connecting rod 12 relative to the crank rotational axis KDA, which causes the guide element axis FA to move in the guide direction FR.

The central gear 54 is locked in place in its setting position, in particular by the worm gear 60. As a result, the setting position of the central gear 54 remains unchanged during the rotation of the crank 22 and is maintained until the next change in the setting position.

FIG. 8 is an exploded view of the second embodiment of the drive device 10. Via the eccentric unit bearing 34, the eccentric unit 26 of the drive device 10 is connected to the crank 22, which is mounted on a shaft 24 on a housing (not shown here) so that it can rotate about its crank rotational axis KDA. The eccentric unit 26 is adapted to be rotated about the eccentric unit bearing rotational axis ELA.

Furthermore, the eccentric unit 26 is connected to the connecting rod eye 16 via the eye-type bearing 32, which is adapted to be rotated about the eye-type bearing rotational axis ALA.

The guide element axis FA of the guide element 20 is mounted so that it pivots about the eye-type bearing rotational axis ALA via the connecting rod 12, the connecting rod eye 16 of which houses the eye-type bearing 32. The eye-type bearing axis ALA is spaced at a distance d from the eccentric unit bearing rotational axis ELA, with the fixed distance D of the eccentric unit bearing rotational axis ELA from the crank rotational axis KDA being greater than the distance d from the eye-type bearing axis ALA. The eye-type bearing axis ALA exhibits an eccentricity EZ relative to the crank rotational axis KDA.

When the crank 22 rotates, a connecting line VL, which is orthogonal to the crank rotational axis KDA and to the eccentric unit bearing rotational axis ELA and which connects the crank rotational axis KDA to the eccentric unit bearing rotational axis ELA, pivots about the crank rotational axis KDA. When the guide element axis FA has the largest deflection Sₘₐₓ relative to the crank rotational axis KDA, the first guide element position 27 is allocated to the guide element 20, which coincides with the first crank position 28 of the crank 22, and the guide element axis FA is in the same plane as the connecting line VL.

At a crank angle of 180° starting from the first crank position 28, the crank 22 is allocated to a second crank position 30, which coincides with a rear dead center. In conjunction with the second crank position 30, a second guide element position 29 is allocated to the guide element 20, in which the guide element axis FA has the smallest deflection Sₘᵢₙ relative to the crank rotational axis KDA, with the guide element axis FA being in the same plane as the connecting line VL. The distance between the first guide element position 27 and the second guide element position 29 corresponds to a stroke length H of the crank mechanism.

The orbit of the eye-type bearing axis ALA around the crank rotational axis KDA results from one revolution of the crank 22, with a distance EZ of the eye-type bearing axis ALA from the crank rotational axis KDA changing within one revolution of the crank 22.

The eccentricity EZ of the eye-type bearing axis ALA relative to the crank rotational axis KDA can be adjusted by the mechanical action of the central gear 54 on the gear 56. The central gear 54 is arranged coaxially relative to the crank rotational axis KDA. The angular orientation of the central gear 54 about the crank rotational axis KDA can be adjusted via the adjusting device 44. For this purpose, the worm shaft 64 of the worm drive 60 is adjusted axially, thus causing the worm wheel 62 and the central gear 54, which latter is connected to the worm wheel 62 in a rotationally fixed manner, to turn.

The central gear 54 is operatively connected to the gear 56 via respective external toothing 58. As a result, the gear 56, which is coaxially connected to the eccentric unit bearing rotational axis ELA and firmly connected to the eye-type bearing 32, will also turn when the central gear 54 is adjusted.

This involves adjusting the eye-type bearing 32. This causes the position of the eye-type bearing axis ALA to change in relation to the eccentric unit bearing rotational axis ELA, and the eccentricity EZ of the eye-type bearing axis ALA to change in relation to the crank rotational axis KDA. This causes a change of the orbit of the eye-type bearing axis ALA around the crank rotational axis KDA. This results in a change in the angular position of the connecting rod 12, and thus in a change of the position of the guide element axis FA in the guide direction FR, or of the first guide element position 27 and the second guide element position 29. This allows the stroke position of the displacement element connected to the guide element 20 to be adjusted.

The central gear 56 can be locked in place in the setting position via the gear teeth of the worm drive 60. The setting position remains unchanged during rotation of the crank 22. This reliably retains the first guide element position 27 and/or the second guide element position 29 until the next change in the setting position.

The central gear 54 can be locked in place by a locking device 74.

The view of FIG. 9 shows the second embodiment of the drive device 10 in different operating positions A and B, which coincide with the front dead center and the rear dead center, respectively, of the crank 22. In the respective operating positions A, B, the crank rotational axis KDA, the eccentric unit bearing rotational axis ELA and the guide element axis FA are all in one plane. The respective crank rotational axes KDA are aligned.

In the present case, the central gear 54 is in a neutral setting position in relation to the crank rotational axis KDA. In a respective setting position, the central gear 54 is fixed in place so that it cannot rotate relative to the crank rotational axis KDA. In the present view, a fixed position 70 of a first tooth 72 of the central gear 54 is marked with an arrow.

In the operating position A, the first crank position 28 is allocated to the crank 22, and the first guide element position 27 is allocated to the guide element axis FA. The guide element axis FA has a maximum deflection Sₘₐₓ relative to the crank rotational axis KDA.

At a crank angle α of 180°, starting from the first operating position A and/or the first guide element position 27, the gear 56 rolls off the central gear 54, and the guide element axis FA moves over a stroke length H in guide direction FR into the second guide element position 29, which coincides with the second operating position B and the rear dead center of the crank 22.

In the operating position B, the guide element axis FA has the smallest deflection Sₘᵢₙ in relation to the crank rotational axis KDA.

An orbit of the eye-type bearing axis ALA about the crank rotational axis KDA is allocated to the neutral setting position of the central gear 54. According to the orbit, the eccentricity EZ of the eye-type bearing axis ALA relative to the crank rotational axis KDA changes within one revolution of the crank 22, with the eccentricity at the front dead center being designated EZ-1 and at the rear dead center being designated EZ-2. In the neutral setting position, the eccentricity EZ-1 at the front dead center and the eccentricity EZ-2 at the rear dead center are of the same extent, compare operating position A with operating position B.

The orbit of the eye-type bearing axis ALA about the crank rotational axis KDA is associated with a to-and-fro movement of the connecting rod 12 and an essentially linear movement of the guide element axis FA in the guide direction FR and/or of a displacement element connected to the guide element 20. Thus, the orbit of the eye-type bearing axis ALA about the crank rotational axis KDA is allocated to a respective stroke position of the guide element axis FA, which is associated with the first guide element position 27 and the second guide element position 29.

Rotation of the central gear 54 causes the gear 56 to rotate and the eye-type bearing axis ALA to rotate about the eccentric unit bearing rotational axis ELA. As a result, the orbit of the eye-type bearing axis ALA is displaced around the crank rotational axis KDA, causing the connecting rod 12 to be displaced and consequently the first guide element position 27 and the second guide element position 29 to be displaced.

Starting from the neutral setting position, the setting position of the central gear 54 can be adjusted about its rotational axis DA, which is coaxial relative to the crank rotational axis KDA, in the one direction of rotation, see FIG. 10, and in the respective other direction of rotation, see FIG. 11, by the worm wheel 62. This allows the stroke position to be changed.

As seen in FIG. 10, the setting position of the central gear 54 is adjusted by means of the worm drive 60 by a maximum angle of rotation relative to the neutral setting position of the central gear 54 in a direction of rotation, in particular clockwise. As a result, the position 70 of the tooth 72 is realigned relative to the neutral setting position. The gear 56, which is operatively connected to the central gear 54, is also turned. This changes the orientation of the eye-type bearing axis ALA relative to the eccentric unit bearing rotational ELA and the crank rotational axis KDA, compare FIG. 10 with FIG. 9.

Changing, in particular maximizing, the eccentricity EZ of the eye-type bearing axis ALA relative to the crank rotational axis KDA, causes a change of the orbit of the eye-type bearing axis ALA about the crank rotational axis KDA relative to the neutral setting position. In the present case, the eccentricity EZ-1 at the front dead center is increased compared to the neutral setting position, and the eccentricity EZ-2 of the rear dead center is reduced, so that EZ-1>EZ-2.

This shifts the deflection of the connecting rod 12 in the guide direction FR, in particular the deflection is increased. In the present case, the guide element axis FA is adjusted by the extent M in the guide direction FR relative to the first guide element position 27, which coincides with the neutral adjustment position.

At a crank angle α of 180°, starting from the first operating position A, the guide element axis FA moves over a stroke length H into the second guide element position 29, which coincides with the second operating position B, the rear dead center and the smallest deflection Sₘᵢₙ of the guide element axis FA relative to the crank rotational KDA. The change in the eccentricity of the eye-type bearing axis ALA relative to the crank rotational axis KDA also causes the orbit of the eye-type bearing axis ALA around the crank rotational axis KDA to change, with the distance D of the eccentric unit bearing rotational axis ELA from the crank rotational axis remaining constant. As a result, the second guide element position 29 allocated to the neutral setting position is displaced relative to the crank rotational axis KDA by the same extent M in the guide direction FR.

The change in the eccentricity EZ of the eye-type bearing rotational axis ALA in relation to the crank rotational axis KDA results in an increase of the deflection Sₘₐₓ and the deflection Sₘᵢₙ between the guide element axis FA and the crank rotational axis KDA by the same extent M in the guide direction FR. This means that the stroke position of the displacement element can be adjusted by the extent M without changing the stroke length.

As seen in FIG. 11, the setting position of the central gear 54 is set in the opposite direction of rotation, counterclockwise relative to the neutral setting position.

At the present maximum angle of rotation of the central gear 54 relative to the crank rotational axis KDA, the position 70 of the first gear 72 is adjusted counterclockwise relative to the neutral setting position, see FIG. 9. Analogously, the gear 56 is also rotated and the eye-type bearing axis ALA is displaced with respect to the eccentric unit bearing rotational axis ELA and the crank rotational axis KDA. As a result, the eccentricity EZ of the eye-type bearing axis ALA is shifted relative to the crank rotational axis KDA relative to the neutral setting position, which changes the orbit of the eye-type bearing axis ALA about the crank rotational axis KDA. In this case, the eccentricity EZ-1 at the front dead center is reduced compared to the neutral setting position, and the eccentricity EZ-2 of the rear dead center is increased. Consequently, EZ-1<EZ-2.

Adjusting the eye-type bearing axis ALA causes a deflection of the connecting rod 12 to be shifted, in particular reduced. The largest deflection Sₘₐₓ and the smallest deflection Sₘᵢₙ between the guide element axis FA and the crank rotational axis KDA are reduced by the same extent M in the guide direction FR, so that, overall, the stroke position of the displacement element is shifted by the extent M.

A respective setting position of the central gear 54 coincides with a respective stroke position of the displacement element connected to the guide element 20, the stroke position being continuously adjustable by the extent M, in particular between 0 mm and 10 mm.

1-18. (canceled)

19. A drive device (10) for output movement of a displacement element, comprising:
a connecting rod (12), wherein the connecting rod (12) comprises a connecting rod eye (16) at a first end (14) thereof and a guide element (20) at a second end (18) thereof, the guide element (20) is connected to the displacement element, with the guide element (20) being mounted in such a way that it essentially executes a translatory movement in a guide direction (FR),
a crank (22), wherein the crank (22) comprises a crank arm or a crank wheel and is mounted so that it is rotatable about a crank rotational axis (KDA), and
an eccentric unit (26), wherein the eccentric unit (26) comprises an eye-type bearing (32) and an eccentric unit bearing (34), the eccentric unit (26) is connected via the eye-type bearing (32), which has an eye-type bearing axis (ALA), to the connecting rod eye (16) in such a way that the connecting rod eye (16) is rotatable about the eye-type bearing axis (ALA), with the eccentric unit (26) being mounted on the crank arm or crank wheel via the eccentric unit bearing (34), with the eccentric unit bearing (34) defining an eccentric unit bearing rotational axis (ELA) which is arranged at a fixed distance (D) from the crank rotational axis (KDA),
wherein a first guide element position (27) is allocated to the guide element (20), in which the crank rotational axis (KDA), the eccentric unit bearing rotational axis (ELA), and the guide element axis (FA) are all in one plane,
wherein the eccentric unit (26) is designed in such a way that the rotation of the eccentric unit (26) about the eccentric unit bearing rotational axis (ELA) results in an orbit of the eye-type bearing axis (ALA) about the crank rotational axis (KDA), according to which the distance (EZ) of the eye-type bearing axis (ALA) from the crank rotational axis (KDA) changes within one revolution of the crank (22),
wherein the eccentric unit (26) comprises a mechanical setting device (36), the mechanical setting device (36) comprises a setting element (38) that acts on an eccentric element (40) the setting device (36) being designed such that the setting element (38) is configured to adopt different setting positions relative to the crank rotational axis (KDA), specifically position and/or orientation, wherein the setting element (38) is lockable in the setting position, and
wherein an orbit of the eye-type bearing axis (ALA) around the crank rotational axis (KDA) is allocated to an adjustment position.

20. The drive device according to claim 19, wherein the eccentric element (40) is mounted on the crank (22) via the eccentric unit bearing (34) so as to be rotatable about the eccentric unit bearing rotational axis (ELA), and the eye-type bearing (32) is connected to the eccentric element (40) in such a way that the eye-type bearing axis (ALA) is arranged so as to be rotatable at a constant distance (d) about the eccentric unit bearing rotational axis (ELA).

21. The drive device according to claim 19, wherein the eccentric unit (26) comprises an adjusting device being operatively connected to the setting element (38) in such a way that actuation of the adjusting device changes the position of the eye-type bearing axis (ALA), at an associated crank angle (α), with respect to the crank rotational axis (KDA), the adjusting device further comprises a locking device that locks the setting element (38) in place in the setting position, in particular in a positive-locking manner.

22. The drive device according to claim 21, wherein the adjusting device (44) comprises a drive structure for accommodating a rotary movement.

23. The drive device according to claim 22, wherein the adjusting device (44) comprises a motor (52), the motor (52) is an electric motor that is connected to the drive structure.

24. The drive device according to claim 23, wherein the adjusting device (44) comprises a control device that controls the motor (52).

25. The drive device according to claim 24, wherein the control device comprises a memory unit, the memory unit stores a set of operating parameters so that an allocated setting position of the setting element (38) is set via the controlled motor (52) as a function of the set of the operating parameters.

26. The drive device according to claim 21, wherein the adjusting device (44) comprises an adjusting gear that is designed as a self-locking gear.

27. The drive device according to claim 26, wherein the adjusting gear comprises a screw element (50) with a thread, the screw element (50) acts between the drive structure and the setting element (38), and the thread is of a self-locking design.

28. The drive device according to claim 20, wherein the eccentric element (40) is a gear (56), and the setting element (38) is a central gear (54) that is mounted coaxially with and rotatable about the crank rotational axis (KDA) via the adjusting gear, the central gear (54) is lockable in place via the adjusting gear and interacts with the gear (56) in its locked state in such a way that the gear (56) rotates relative to the crank (22) when the crank (22) rotates.

29. The drive device according to claim 28, wherein the adjusting gear is a worm gear (60) comprising a worm wheel (62), the worm wheel (62) is connected to the central gear (54) in a rotationally fixed manner, with the threaded screw element (50) comprising a worm shaft (64) that is in mesh with the worm wheel (62).

30. The drive device according to claim 28, wherein the gear (56) and the central gear (54) comprise an equal number of teeth.

31. The drive device according to claim 20, wherein the eccentric element (40) is a lever (41) that is pivotable about the eccentric unit bearing rotational axis (ELA) by a pivoting angle (β), with the position of the eye-type bearing axis (ALA) relative to the crank rotational axis (KDA) being changed as a function of the pivoting angle (β) of the lever (41), the pivoting movement of the lever (41) being implemented by a motion link system comprising the setting element (38).

32. The drive device according to claim 31, wherein the setting element (38) is a link block (39) of the motion link system, the link block (39) is rotatably mounted about an rotational axis (DA) that is parallel to the crank rotational axis (KDA) and the lever (41) comprises a motion link (42), in a form of a slotted hole along the lever (41), so that the pivoting angle of the lever (41) changes over a revolution depending on a distance of the link block (39) from the crank rotational axis (KDA).

33. The drive device according to claim 32, wherein the adjusting gear is a spindle gear (46) being connected to the link block (39).

34. The drive device according to claim 33, wherein the spindle gear (46) comprises a spindle axis (SA) that is orthogonal to the crank rotational axis (KDA).

35. The drive device according to claim 21, wherein the adjusting device (44) comprises a locking device (74), and the locking device (74) fixes the setting element (38) in place in a setting position.

36. An apparatus for producing threads and profiles on blanks, comprising:
a rolling die arrangement, wherein the rolling die arrangement consists of a stationary rolling die and a movable rolling die that are guided parallel to one another in a guide direction (FR),
the movable rolling die is connected to the drive device (10) as described in claim 19 for producing a translatory movement relative to the stationary rolling die, and
the drive device (10) comprises an adjustable eccentric unit (26) for aligning the rolling dies with one another.
